(19) United States
(12) Patent Application Publication
(10) Pub. No.: US 2026/0011461 A1
(43) Pub. Date: Jan. 8, 2026

(54) POOL-TYPE NUCLEAR REACTOR SYSTEM HAVING A PARALLEL FLOW PATH FOR RESIDUAL HEAT REMOVAL

(71) Applicant: Korea Atomic Energy Research Institute, Daejeon (KR)

(72) Inventors: Yong Bum LEE, Daejeon (KR); Jew Han Lee, Daejeon (KR); Jung Yoon, Daejeon (KR); Yong Hoon Shin, Gyeryong-si (KR); Byeong Yeon Kim, Daejeon (KR); Young II Cho, Daejeon (KR); Seung Joon Baik, Daejeon (KR); Jae Hyuk Eoh, Daejeon (KR)

(73) Assignee: Korea Atomic Energy Research Institute, Daejeon (KR)

(21) Appl. No.: 18/978,837

(22) Filed: Dec. 12, 2024

(30) Foreign Application Priority Data
Jul. 2, 2024 (KR) 10-2024-0086814

(51) Int. Cl. G21C 15/243; G21C 1/03; G21C 15/18

(52) U.S. Cl. CPC G21C 15/243; G21C 1/03; G21C 15/182

(57) ABSTRACT

A pool-type nuclear reactor system including a normal coolant circulation flow path configured that, during normal operation, after a low-temperature coolant pumped by a pump located in a low-temperature pool flows into a core inlet plenum, the coolant is heated while passing through the core, and is accommodated into a high-temperature pool, and a high-temperature coolant located in a high-temperature pool is cooled while passing through an intermediate heat exchanger and is re-introduced into the low-temperature pool; an emergency coolant circulation flow path configured that, in the event of a power outage accident, the high-temperature coolant located in the high-temperature pool heated by the core is cooled while passing through an auxiliary cooling system, and then is re-introduced into the core through the pump and the core inlet plenum; and a parallel flow path for residual heat removal configured to connect the core inlet plenum and the low-temperature pool.

### CROSS REFERENCE TO RELATED APPLICATION

The present application claims the priority of Korean Patent Application No. 10-2024-0086814, filed on Jul. 2, 2024, the entire contents of which is incorporated herein for all purposes by this reference.

### BACKGROUND OF THE INVENTION

### Field of the Invention

The present invention relates to a pool-type nuclear reactor system equipped with a parallel flow path for residual heat removal to efficiently remove residual heat generated in a core in the event of a nuclear power plant accident.

### Description of the Related Art

In the event of any accident, including a power outage at a nuclear power plant, the nuclear reactor will be shut down and the reactor coolant pump that require power supply may also be shut down.

On the other hand, even after the nuclear reactor is shut down, decay heat continues to be generated within the core. If all residual heat including this decay heat is not removed, the temperature and pressure of the coolant, including the core, will rise, and in the worst case, the engineering safety barrier may fail, leading to an accident in which radioactive materials leak to the outside.

Therefore, residual heat removal is very important to ensure the safety of the nuclear reactor. A residual heat removal system (RHRS) is essential to release residual heat to the outside of the nuclear reactor even after the reactor is shut down. The residual heat removal system must have high reliability and utilize a natural circulation phenomenon that does not require driving force such as a pump.

As a method for removing residual heat from the core, the DRACS (Direct Reactor Auxiliary Cooling System) means, which releases residual heat into the atmosphere using two heat exchangers, and the RVACS (Reactor Vessel Auxiliary Cooling System) means, which releases residual heat into the atmosphere through heat exchange by convection and radiation using an outer wall of the nuclear reactor vessel as a heat transfer surface without a heat exchanger, may be considered.

In order to release residual heat generated in the core to the outside, it is necessary to first transfer residual heat generated in the core to the heat exchanger of the residual heat removal system in case of the DRACS and to a wall surface of the nuclear reactor vessel in case of the RVACS.

If the nuclear reactor coolant pump is shout down after an accident, a driving force by the pump disappears, and the driving force of the natural circulation flow rate is generated by a difference in the density and height according to the location of the coolant in the primary system of the nuclear reactor. The natural circulation flow rate is determined by the balance between the driving force and the flow resistance of the core and pump in the natural circulation flow path. In order to obtain a maximum natural circulation flow rate, the nuclear reactor design may reflect factors such as reducing the flow resistance, increasing a difference in the height between the core (the heat source) and the heat sink, and providing additional driving force.

However, in case of the existing concept, if sufficient natural circulation flow rate passing through the core is not formed initially, or if the fully developed total natural circulation flow rate is smaller than predicted, there is a problem that an amount of heat released to the outside cannot keep up with residual heat generated in the core so that an outlet temperature of the core is continuously increased.

### SUMMARY OF THE INVENTION

The first purpose of the present invention is to provide a pool-type nuclear reactor system equipped with a parallel flow path for residual heat removal, that can efficiently form a natural circulation flow rate circulating through a primary system to control a rapid increase in the maximum temperature at a core outlet, by directly connecting the final heat sink and the core for residual heat removal in the early stage of a power outage accident at a nuclear power plant.

The second purpose of the present invention is to provide a pool-type nuclear reactor system equipped with a parallel flow path for residual heat removal, that can efficiently reduce a core inlet and outlet temperatures by simplifying a heat transfer path from the core to the final heat sink by reducing the time required for the full development of a natural circulation flow rate.

In order to achieve the above purposes, the present invention discloses a pool-type nuclear reactor system comprising: a normal coolant circulation flow path configured that, during normal operation, after a low-temperature coolant pumped by a pump located in a low-temperature pool flows into a core inlet plenum, the coolant is heated while passing through the core, and is accommodated into a high-temperature pool, and a high-temperature coolant located in a high-temperature pool is cooled while passing through an intermediate heat exchanger and is re-introduced into the low-temperature pool; an emergency coolant circulation flow path configured that, in the event of a power outage accident, the high-temperature coolant located in the high-temperature pool heated by the core is cooled while passing through an auxiliary cooling system, and then is re-introduced into the core through the pump and the core inlet plenum; and a parallel flow path for residual heat removal configured to connect the core inlet plenum and the low-temperature pool and be connected in parallel with the normal coolant circulation flow path and the emergency coolant circulation flow path.

The parallel flow path for residual heat removal may have a greater flow resistance than that of the core and the pump.

According to an embodiment of the present invention, during normal operation, the coolant may be branched at the core inlet plenum, and flow in parallel to the core and a connecting flow path to flow into the low-temperature pool. In the event of a power outage accident, the coolant may be branched at the low-temperature pool, and flow in parallel to the pump and the parallel flow path for residual heat removal to flow into the core inlet plenum.

In order to achieve the above purposes, the present invention also discloses a pool-type nuclear reactor system comprising: a normal coolant circulation flow path configured that after a low-temperature coolant pumped by a pump located in a low-temperature pool flows into a core inlet plenum, the coolant is heated while passing through the core, and is accommodated into a high-temperature pool, and, during normal operation, a high-temperature coolant located in a high-temperature pool is cooled while passing through an intermediate heat exchanger and is re-introduced into the low-temperature pool; an emergency coolant circulation flow path configured that, in the event of a power outage accident, after the high-temperature coolant located in the high-temperature pool heated by the core is re-introduced into the low-temperature pool, the coolant flows into the core inlet plenum through the pump and is cooled during the re-introduction process or after the re-introduction; and a parallel flow path for residual heat removal configured to connect the core inlet plenum and the low-temperature pool so that, during normal operation, a portion of the low-temperature coolant located in the core inlet plenum flows to the low-temperature pool, and, in the event of a power outage accident, a portion of the low-temperature coolant located in the low-temperature pool flows to the core inlet plenum.

In order to achieve the above purposes, the present invention also discloses a pool-type nuclear reactor system characterized by comprising: a core unit having a core and a core inlet plenum; a high-temperature pool for accommodating a high-temperature coolant heated while passing through the core; an intermediate heat exchanger for heat exchange with the high-temperature coolant of the high-temperature pool during normal operation; an auxiliary cooling system for cooling while flowing the high-temperature coolant in the event of a power outage accident; a low-temperature pool for accommodating a low-temperature coolant cooled by the intermediate heat exchanger or the auxiliary cooling system; a pump that provides a driving force for flowing the low-temperature coolant located in the low-temperature pool into the core inlet plenum; and a parallel flow path for residual heat removal that connects the core inlet plenum and the low-temperature pool and allowing the coolant to flow, wherein the parallel flow path for residual heat removal has a preset flow resistance so that the coolant can flow from the core inlet plenum to the low-temperature pool during normal operation and flow from the low-temperature pool to the core inlet plenum in the event of a power outage accident.

The effects of the present invention obtained through the above-described solution are as follows.

First, in the event of a power outage accident, a natural circulation flow is formed due to a difference in the density of the coolant between the core and the heat exchanger. The naturally circulating coolant flows in parallel to the emergency coolant circulation flow path through which the coolant flows from the low-temperature pool to the core inlet plenum via the pump and the parallel flow path for residual heat removal through which the coolant flows directly from the low-temperature pool to the core inlet plenum. Since the flow resistances are connected in parallel, the overall flow resistance is reduced. Accordingly, A flow rate passing through the core increases compared to a single flow path, which can control a rapid rise in the maximum temperature at the core outlet in the early stage.

Second, as the flow rate passing through the core increases, the fully developed natural circulation flow rate releases a greater amount of heat to the outside of the nuclear reactor than the residual heat newly generated in the core, which can efficiently reduce the temperatures at the core inlet and outlet in the long term.

### BRIEF DESCRIPTION OF THE DRAWINGS

FIG. 1 is circuit diagrams showing a coolant circulation flow path in a nuclear reactor system for residual heat removal according to an embodiment of the present invention, (a) of FIG. 1 is a circuit diagram showing the coolant circulation flow path during normal operation, and (b) of FIG. 1 is a circuit diagram showing a coolant circulation flow path in the event of a power outage accident.

FIG. 2 is front views of a nuclear reactor including an RVACS type auxiliary cooling system according to an embodiment of the present invention, (a) of FIG. 2 is a conceptual diagram showing flow of a coolant during normal operation, and (b) of FIG. 2 is a conceptual diagram showing flow of a coolant in the event of a power outage accident.

FIG. 3 is front views of a nuclear reactor including an DRACS type auxiliary cooling system according to another embodiment of the present invention, (a) of FIG. 3 is a conceptual diagram showing flow of a coolant during normal operation and (b) of FIG. 3 is a conceptual diagram showing flow of a coolant in the event of a power outage accident.

FIG. 4 is a graph showing a change in the temperature of coolants at core inlet and outlet after a power outage accident, which compares an embodiment of the present invention with an embodiment of a single flow path.

FIG. 5 is a graph showing an amount of residual heat generated in the core and an amount of heat released to the outside through the residual heat removal system after a power outage accident, which compares an embodiment of the present invention with an embodiment of a single flow path.

FIG. 6 is a graph showing a change in the temperature of coolants at the inlet and outlet of core according to a ratio of the area of the parallel flow path for residual heat removal compared to the area of the core of the present invention.

FIG. 7 is a table showing a change in the flow rate and the pump depending on a ratio of the area of the parallel flow path for residual heat removal of the present invention during normal operation.

FIG. 8 is a graph showing an amount of heat released to the outside through the residual heat removal system according to an air flow rate at the outer wall of the nuclear reactor vessel in a nuclear reactor including an RVACS type auxiliary cooling system by comparing an embodiment of the present invention with an embodiment of a single flow path, (a) of FIG. 8 is a graph comparing when the air flow rate at the outer wall of the nuclear reactor vessel is 0.04 kg/s, and (b) of FIG. 8 is a graph when the air flow rate at the outer wall of the nuclear reactor vessel is 1.00 kg/s.

### DETAILED DESCRIPTION OF THE INVENTION

Hereinafter, a Pool-type nuclear reactor system equipped with a parallel flow path for residual heat removal related to the present invention will be described with reference to the drawings in more detail.

In explaining the embodiments disclosed in this specification, if it is judged that a detailed description of related known technologies may obscure the gist of the embodiments disclosed in this specification, the detailed description thereof will be omitted.

The attached drawings are merely intended to facilitate easy understanding of the embodiments disclosed in this specification. The technical ideas disclosed in this specification are not limited by the attached drawings, and should be understood to cover all modifications, equivalents, or substitutes included in the spirit and technical scope of the present invention.

In the following description, the singular expression includes the plural expression unless the context clearly indicates otherwise.

In this application, the terms “includes” or “has” are intended to designate the presence of features, numbers, steps, operations, components, parts, or combinations thereof described in the specification, and should be understood not to preemptively exclude the possibility of the presence or addition of one or more other features, numbers, steps, operations, components, parts, or combinations thereof.

In case it is mentioned that a certain component is “linked” or “connected” to another component, it should be understood that the certain component may be directly linked or connected to another component, but that there may be other components in between them. On the other hand, in case it is mentioned that a certain component is “directly linked” or “directly connected” to another component, it should be understood that there are no other components in between them.

In this specification, the same or similar reference numbers are assigned to the same or similar components even in different embodiments, and redundant descriptions thereof are omitted.

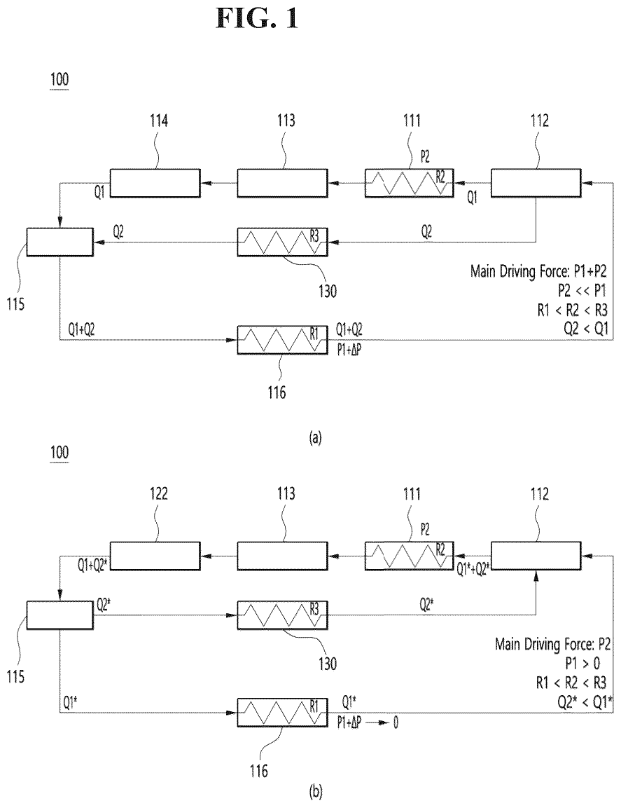

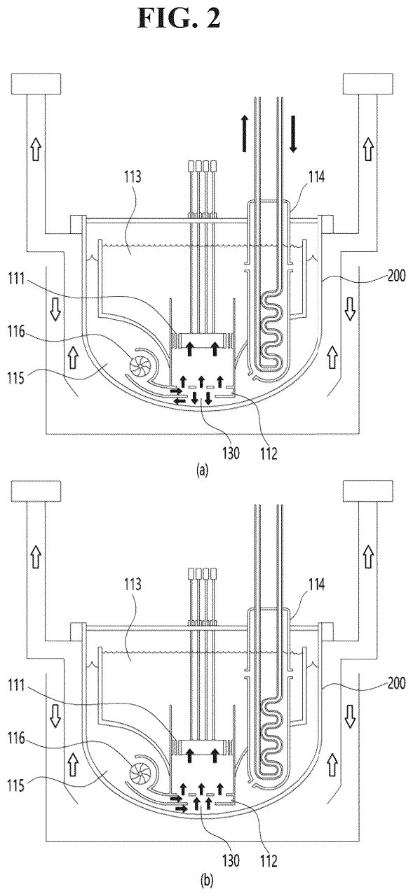

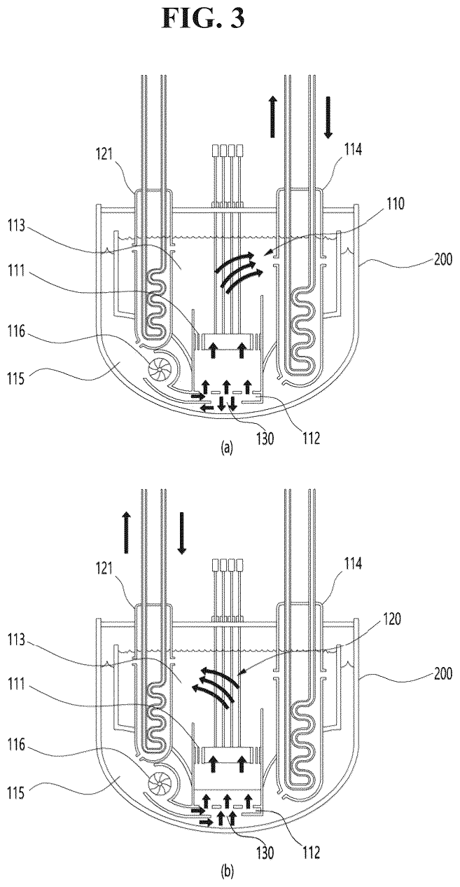

FIG. 1 shows a coolant circulation flow path in a nuclear reactor system for residual heat removal 100 according to an embodiment of the present invention, (a) of FIG. 1 is a circuit diagram showing the coolant circulation flow path during normal operation, and (b of FIG. 1 is a circuit diagram showing a coolant circulation flow path in the event of a power outage accident. FIG. 2 is front views of a nuclear reactor including an RVACS type auxiliary cooling system according to an embodiment of the present invention, (a) of FIG. 2 is a conceptual diagram showing flow of a coolant during normal operation, and (b) of FIG. 2 is a conceptual diagram showing flow of a coolant in the event of a power outage accident. FIG. 3 is front views of a nuclear reactor including an DRACS type auxiliary cooling system according to another embodiment of the present invention, (a) of FIG. 3 is a conceptual diagram showing flow of a coolant during normal operation and (b) of FIG. 3 is a conceptual diagram showing flow of a coolant in the event of a power outage accident.

Referring to FIGS. 1 to 3, the nuclear reactor system for residual heat removal 100 according to an embodiment of the present invention comprises a normal coolant circulation flow path, an emergency coolant circulation flow path, and a parallel flow path for residual heat removal 130.

The normal coolant circulation flow path 110 refers to a flow path through which the coolant sequentially flows and circulates to a pump 116, a core inlet plenum 112, a core 111, a high-temperature pool 113, an intermediate heat exchanger 114, a low-temperature pool 115, and the pump 116 in (a) of FIG. 1. The emergency coolant circulation flow path 120 refers to a flow path through which the coolant sequentially flows and circulates to the core 111, the high-temperature pool 113, an auxiliary cooling system 122, the low-temperature pool 115, the pump 116, the core inlet plenum 112, and the core 111 in (b) of FIG. 1. The parallel flow path for residual heat removal 130 refers to a flow path connecting the core inlet plenum 112 and the low-temperature pool 115 in (a) and (b) of FIG. 1.

During normal operation, the coolant may flow along the normal coolant circulation flow path 110. The normal coolant circulation flow path 110 is located inside a nuclear reactor vessel 200, and its circulation process is as follows.

The low-temperature coolant is pumped from the pump 116 located in the low-temperature pool 115 and flows into the core inlet plenum 112 of the core unit. The core unit is located inside the low-temperature pool 115 and may be configured of the core inlet plenum 112 and the core 111.

At the core inlet plenum 112, the coolant is branched so that a portion thereof flows into the core 111 and the remaining portion flows into the parallel flow path for residual heat removal 130 to be described later. Herein, the remaining portion may be smaller than the above portion. The core 111 may be located above the core inlet plenum 112.

The coolant flowing into the core 111 is heated by the heat generated by nuclear fission and is accommodated into the high-temperature pool 113 in a low-density, high-temperature state. The high-temperature pool 113 may be located inside the low-temperature pool 115.

The coolant accommodated into the high-temperature pool 113 flows into the intermediate heat exchanger 114. A upper end part of the intermediate heat exchanger 114 is located in the high-temperature pool 113 and a lower end part thereof is located in the low-temperature pool 115, thereby forming a flow path through which the coolant can flow from the high-temperature pool 113 to the low-temperature pool 115. The high-temperature coolant introduced from the high-temperature pool 113 may transfer heat to the coolant (second coolant) flowing inside the intermediate heat exchanger 114 and be cooled. The second coolant may lead to a secondary system that generates electricity.

The cooled low-temperature coolant of a high density is accommodated into the low-temperature pool 115 and may be circulated by being re-introduced into the pump 116 located in the low-temperature pool 115.

Meanwhile, in the event of a power outage accident, the coolant may flow along the emergency coolant circulation flow path 120.

The pump 116 is stopped so that the driving force by the pump 116 is lost, but the coolant obtains the driving force by virtue of a difference in the density during heating and cooling.

The coolant passing through the core 111 becomes a high-temperature and low-density state, and rises due to buoyancy to flow into the high-temperature pool 113.

The high-temperature coolant accommodated into the high-temperature pool 113 is re-introduced into the low-temperature pool 115, and the coolant is cooled during the re-introduction process or after the re-introduction. The high-temperature coolant flows through the auxiliary cooling system 122 and is cooled to become a low-temperature and high-density state.

The low-temperature coolant is branched at the low-temperature pool 115 so that a portion thereof flows into the pump 116, and the remaining portion flows into a connecting flow path 130 to be described later. Herein, the remaining portion may be smaller than the above portion.

The pump 116 is in a stopped state and may serve as a flow path through which the coolant flows. The coolant passing through the pump 116 is re-introduced into the core 111 through the core inlet plenum 112.

For example, as shown in FIG. 2, the auxiliary cooling system 122 may utilize a RVACS means that releases residual heat into the atmosphere through heat exchange with the natural circulation air on a wall surface of the nuclear reactor vessel. In this case, the driving force for flowing the coolant is generated due to a difference in the density of the coolant which results from heating of the coolant in the core 111 and cooling of the coolant through heat exchange on the wall surface of the nuclear reactor vessel 200.

The high-temperature coolant passes through the intermediate heat exchanger 114, but flows into the low-temperature pool 115 without heat exchange. Then, after the coolant is cooled in the low-temperature pool 115 by heat exchange with a natural circulation air through the wall surface of the nuclear reactor vessel 200, the coolant may flow into the pump 116 and the parallel flow path for residual heat removal 130 to be described later, and be circulated.

In case of the RVACS, an air-cooling means in which the high-temperature coolant inside the nuclear reactor vessel 200 exchanges heat with the air naturally circulating on an outer wall surface of the nuclear reactor vessel 200 through convection and radiation is used as an example in the present invention, but a water-cooling means in which a liquid such as water circulates on the outer wall surface of the nuclear reactor vessel 200 and exchanges heat with the internal coolant may also be used.

As another example, as shown in FIG. 3, the auxiliary cooling system 122 may use the DRACS means that releases residual heat into the atmosphere by utilizing the number of a plurality of heat exchangers of the residual heat removal system that are sequentially connected. In this case, the driving force for flowing the coolant is generated due to a difference in the density of the coolant which results from heating of the coolant in the core 111 and cooling of the coolant by a heat exchanger 121 of the first residual heat removal system.

The high-temperature coolant accommodated into the high-temperature pool 113 is cooled by heat exchange with the coolant (third coolant) flowing inside the heat exchanger 121 of the first residual heat removal system located in the high-temperature pool 113, and then flows into the low-temperature pool 115 in the cooled state, wherein the third coolant exchanges heat with air through a heat exchanger of a second residual heat removal system located outside the nuclear reactor vessel 200 to release residual heat into the atmosphere. The heat exchanger of the second residual heat removal system may be connected to a heat exchanger of another residual heat removal system.

In case of the intermediate heat exchanger 114, it may be connected to a configuration such as a pump of the secondary system that provides a driving force for a secondary coolant in the secondary system. Therefore, during normal operation, the secondary coolant is circulated by the pump of the secondary system, and the coolant flows into the intermediate heat exchanger 114 to exchange heat with the secondary coolant. In the event of a power outage accident, the coolant flows into the heat exchanger 121 of the first residual heat removal system to perform heat exchange, thereby generating the driving force for flowing the coolant, whereas the intermediate heat exchanger 114 does not perform heat exchange so that the driving force for flowing the coolant is lost. Therefore, most of the natural circulation flow paths are formed through the heat exchanger 121 of the first residual heat removal system.

However, the present invention is not necessarily limited thereto. As another example, the auxiliary cooling system 122 may include both the RVACS and the DRACS.

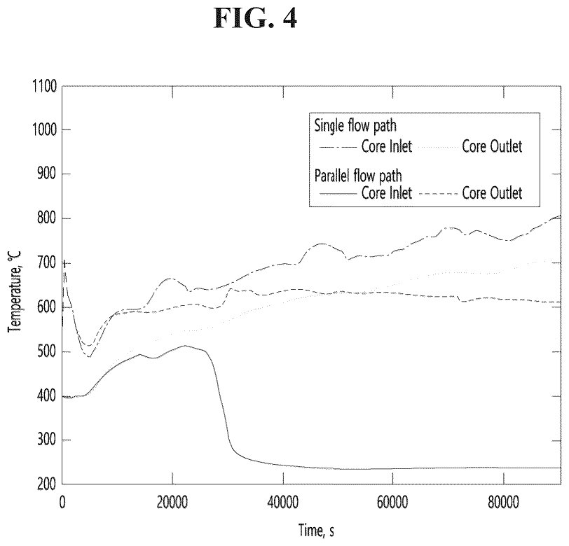

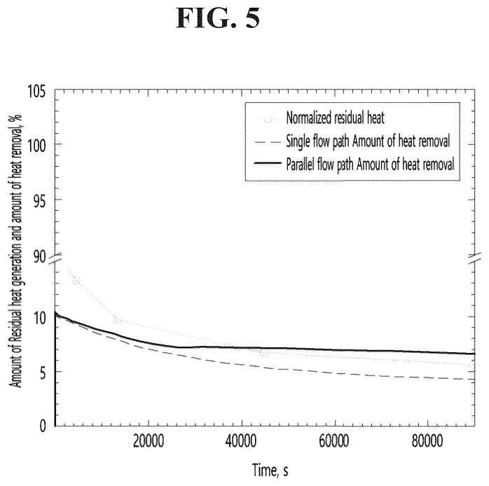

FIG. 4 is a graph showing a change in the temperature of coolants at the inlet and outlet of a core 111 after a power outage accident, which compares an embodiment of the present invention with an embodiment of a single flow path. FIG. 5 is a graph showing an amount of residual heat generated in the core 111 and an amount of heat released to the outside through the residual heat removal system after a power outage accident, which compares an embodiment of the present invention with an embodiment of a single flow path.

In FIG. 5, a heat removal amount of the conventional concept means a single flow path, and a heat removal amount of the new concept means a pool-type nuclear reactor system equipped with a parallel flow path for residual heat removal according to the present invention. The x-axis represents time(s) based on the occurrence of a power outage accident, and the y-axis is an amount of residual heat generation and an amount (%) of heat removal compared to an amount of the initial residual heat generation, which are normalized to the unit by dividing by a maximum value of the initial residual heat.

Referring to FIGS. 4 and 5 together with the previous FIGS. 1 and 2, the parallel flow path for residual heat removal 130 directly connects the core inlet plenum 112 and the low-temperature pool 115, and is equipped in parallel with the normal coolant circulation flow path 110 and the emergency coolant circulation flow path 120. Herein, the phrase of “equipped in parallel” means that from the viewpoint of the pump 116, which is the driving source, during normal operation, the flow of coolant passing through the core 111 and the flow of coolant passing through the parallel flow path for residual heat removal 130 are parallel, and that from the viewpoint of the core 111, which is the driving source, in the event of a power outage accident, the flow of coolant passing through the pump 116 and the flow of coolant passing through the parallel flow path for residual heat removal 130 are parallel.

Although the parallel flow path for residual heat removal may be understood as a connecting flow path from the viewpoint encompassing normal operation and power outage accident, the purpose of the present invention is to improve the efficiency and safety of residual heat removal as will be described later, and therefore it will be named the parallel flow path for residual heat removal from the viewpoint of power outage accident.

The parallel flow path for residual heat removal 130 has a greater flow resistance than the core 111 and the pump 116 so that the coolant can flow from the core inlet plenum 112 to the low-temperature pool 115, and vice versa, flow from the low-temperature pool 115 to the core inlet plenum 112.

During normal operation, the coolant is branched at the core inlet plenum 112 so that a portion thereof flows into the core 111 and the remaining portion flows into the parallel flow path for residual heat removal 130 to form a parallel flow and merge in the low-temperature pool 115.

A portion of the coolant can flow into the parallel flow path for residual heat removal 130 with a relatively large resistance value by the driving force of the pump 116, and the branched flow rate can be determined according to a ratio of the resistance values of the core 111 and the parallel flow path for residual heat removal 130.

In the event of a power outage accident, the coolant cannot flow from the core inlet plenum 112 to the parallel flow path for residual heat removal 130 which has greater resistance than the core 111, because there is no driving force from the pump 116. In this case, the coolant flows from the low-temperature pool 115 to the core inlet plenum 112 through the parallel flow path for residual heat removal 130.

The coolant is branched at the low-temperature pool 115 so that a portion thereof flows to the pump 116 and the remaining portion flows to the parallel flow path for residual heat removal 130 to form a parallel flow and merge in the core inlet plenum 112.

A portion of the coolant can flow into the parallel flow path for residual heat removal 130 with a relatively large resistance value due to the driving force caused by a difference in the density of the coolant in the core 111 and the auxiliary cooling system 122, and the branched flow rate can be determined according to a ratio of the resistance values of the pump 116 and the parallel flow path for residual heat removal 130.

The operation and effect of the nuclear reactor system for residual heat removal 100 due to such a configuration is described.

In the event of a power outage accident, the main driving force of the coolant is generated by a difference in the density that occurs while passing through the core 111. The coolant passing through the core 111 is accommodated into a high-temperature pool 113 in a high-temperature state, cooled through an auxiliary cooling system 122, and then branched at the low-temperature pool 115. The coolant can obtain the driving force due to a difference in the density during the cooling process.

On the basis of the core 111, which is the main driving source, a portion of the coolant is branched at the low-temperature pool 115 to flow into the parallel flow path for residual heat removal 130 and the remining portion of the coolant flows into the flow path passing through the pump 116, so that they form a parallel flow. Since the flow paths are configured in parallel, the overall flow resistance decreases. As the overall flow resistance decreases, the natural circulation flow rate of the coolant passing through the core 111 increases compared to the single flow path under the same condition, thereby increasing the efficiency of residual heat removal.

Referring to FIGS. 4 and 5, which show the experimental results of a nuclear reactor simulation device according to an embodiment of the present invention, it was predicted that a maximum temperature at the inlet and outlet of the core 111 in the event of a power outage accident would be lower than the temperature in case of the existing single flow path, and that the temperature at the inlet and outlet of the core 111 would decrease in the long term. In addition, the calculation results have been derived that the amount of heat released to the outside through the residual heat removal system according to an embodiment would become greater than the residual heat generated in the core 111 in the long term, whereas the existing single flow path could not keep up with the residual heat under the same condition and time.

In the above experiment, the auxiliary cooling system of the nuclear reactor was the RVASC means, and an air flow rate at an outer wall of the nuclear reactor vessel was calculated to be 1.00 kg/s. This calculation was performed using the MARS-LMR computer code developed by the Korea Atomic Energy Research Institute.

In another embodiment of the present invention, the parallel flow path for residual heat removal 130 may perform the function of a coolant-charging and discharging hole that charges the coolant before the nuclear reactor is operated and discharges the coolant after the nuclear reactor's lifespan is terminated.

The parallel flow path for residual heat removal 130 may exist separately from the coolant-charging and discharging hole. When the coolant is charged before operation of the nuclear reactor, the coolant is introduced from the upper part of the nuclear reactor, and the coolant-charging and discharging hole serves as the flow path so as to quickly fill the vessel, but after operation of the nuclear reactor, cannot serve as the flow path through which the coolant flows because it has a large resistance value,.

The parallel flow path for residual heat removal 130 has a smaller flow resistance value than that of the coolant-charging and discharging hole so that it can serve as the flow path through which the coolant can flow during normal operation and in the event of a power outage accident.

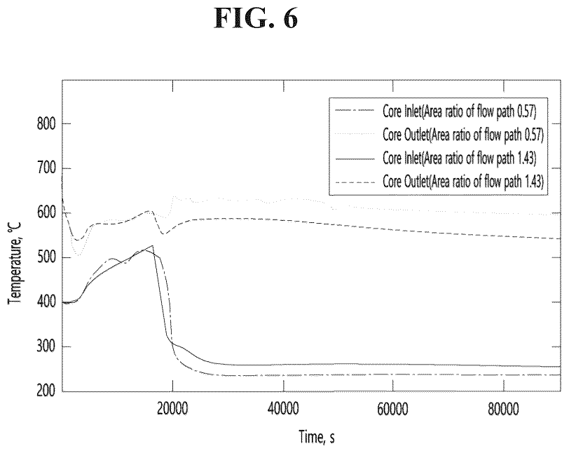

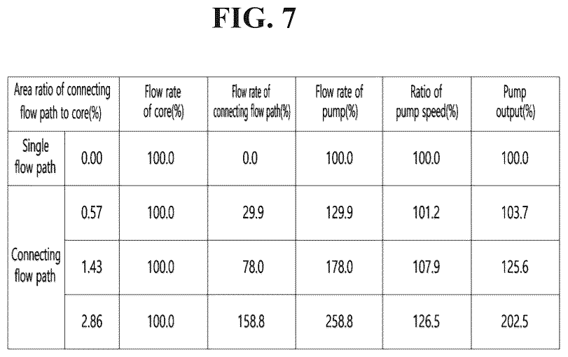

FIG. 6 is a graph showing a change in the temperature of coolants at the inlet and outlet of a core 111 according to a ratio of the area of the parallel flow path for residual heat removal 130 compared to the area of the core 111 of the present invention. FIG. 7 is a table showing a change in the flow rate and the pump 116 depending on a ratio of the area of the parallel flow path for residual heat removal 130 of the present invention during normal operation.

Referring to FIGS. 6 and 7, it is preferred that the ratio of the area of the parallel flow path for residual heat removal 130 to the area of the core 111 is less than 0.85%.

If the coolant is branched at the core inlet plenum 112 during normal operation and a portion thereof flows to the low-temperature pool 115, a flow rate passing through the core 111 decreases compared to the existing single flow path, and the cooling efficiency of the core 111 may decrease. In order to maintain the flow rate passing through the core 111, the output of the pump 116 must be increased, but if the increase rate (AP) is excessive, the efficiency of the nuclear reactor may decrease.

In case the output of the pump 116 is calculated to satisfy 110%, which does not exceed the operating margin of 10%, it is preferable that a ratio of the area of the parallel flow path for residual heat removal 130 to the area of the core 111 is less than 0.85%.

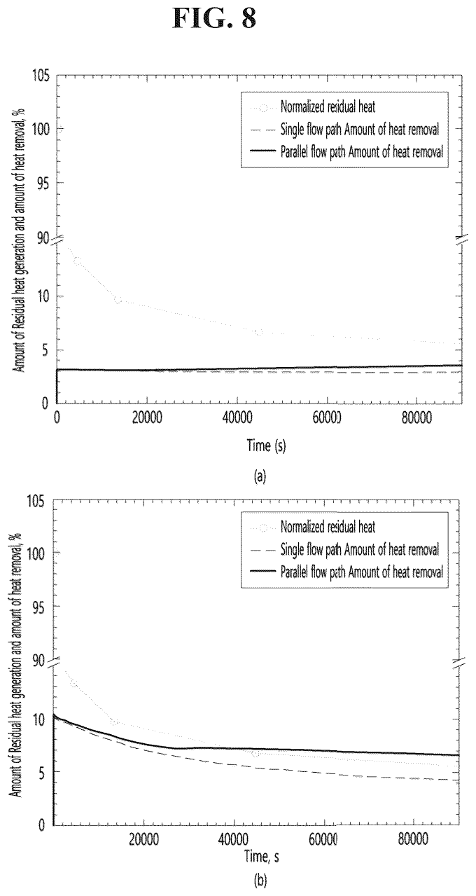

FIG. 8 is a graph showing an amount of heat released to the outside through the residual heat removal system according to an air flow rate at the outer wall of the nuclear reactor vessel in a nuclear reactor including an RVACS type auxiliary cooling system by comparing an embodiment of the present invention with an embodiment of a single flow path, (a) of FIG. 8 is a graph comparing when the air flow rate at the outer wall of the nuclear reactor vessel is 0.04 kg/s, and (b) of FIG. 8 is a graph when the air flow rate at the outer wall of the nuclear reactor vessel is 1.00 kg/s.

In FIG. 8, a heat removal amount of the existing concept means a single flow path, and a heat removal amount of the new concept means a nuclear reactor system including the parallel flow path for residual heat removal 130 of the present invention.

In this case, a ratio of the area of the parallel flow path for residual heat removal 130 to the area of the core 111 is 0.57%. The x-axis represents time(s) based on the occurrence of a power outage accident, and the y-axis is an amount of residual heat generation and an amount (%) of heat removal compared to an amount of the initial residual heat generation, which are normalized to the unit by dividing by a maximum value of the initial residual heat.

Referring to FIG. 8, in a nuclear reactor including an auxiliary cooling system of the RVACS means, it is preferable that an air flow rate at the outer wall of the nuclear reactor vessel 200 is 1.00 kg/s or more.

In case the air flow rate at the outer wall of the nuclear reactor vessel 200 is 0.04 kg/s, since the amount of heat released to the outside through the residual heat removal system is smaller than that of residual heat generated in the core 111 in both an embodiment of the present invention and the single flow path, the calculation result showed that the inlet and outlet temperatures of the core 111 continue to rise.

In case the air flow rate at the outer wall of the nuclear reactor vessel 200 is 1.00 kg/s, the calculation result showed that an amount of heat released to the outside through the residual heat removal system according to an embodiment of the present invention becomes larger than that of residual heat generated in the core 111 at about 40,000 seconds. On the other hand, in case of the single flow path, the calculation result showed that residual heat generated in the core 111 has a larger value than the amount of heat released to the outside through the residual heat removal system, even though the flow rate of the coolant has increased.

In another embodiment of the present invention, the parallel flow path for residual heat removal 130 may be provided in the number of plurality and various shapes.

The parallel flow path for residual heat removal 130 reduces the overall flow resistance by allowing the coolant to flow in parallel with the normal coolant circulation flow path 110 and the emergency coolant circulation flow path 120. If a plurality of parallel flow paths for residual heat removal 130 are provided, the flow resistance can be adjusted according to their shape and arrangement. Therefore, distribution of the flow rate and the temperature can be set according to the designer's intention during normal operation and power outage accident.

In another embodiment of the present invention, the parallel flow path for residual heat removal 130 may be provided with a unidirectional flow restriction mechanism that blocks flow of the coolant through the parallel flow path for residual heat removal 130 during normal operation and allows the coolant branched from the low-temperature pool 115 to flow into the core inlet plenum 112 through the parallel flow path for residual heat removal 130 in the event of a power outage accident. The unidirectional flow restriction mechanism may be a check valve.

The unidirectional flow restriction mechanism is provided in the direction in which the coolant flows from the low-temperature pool 115 to the core inlet plenum 112, so that it can block flow of the coolant from the core inlet plenum 112 to the low-temperature pool 115. During normal operation, the coolant does not flow from the core inlet plenum 112 to the low-temperature pool 115 so that the flow rate of the coolant passing through the core 111 increases even without increasing output of the pump 116.

If the coolant flows from the low-temperature pool 115 to the core inlet plenum 112 in the event of a power outage accident, the unidirectional flow restriction mechanism opens so that the parallel flow path for residual heat removal 130 can function as the flow path.

Since the parallel flow path for residual heat removal 130 is blocked by the unidirectional flow restriction mechanism during normal operation so that there is no loss of the flow rate of the coolant, which leads to no output loss of the pump 116, the area of the parallel flow path for residual heat removal 130 can be set to be larger to increase the natural circulation flow rate passing through the core 111.

The above description is merely exemplary, and various modifications may be made by a person who has an ordinary knowledge in the technical field to which the present invention belongs, without departing from the scope and technical idea of the described embodiments. The above-described embodiments may be implemented individually or in any combination thereof.

### DESCRIPTION OF A SYMBOL

100: Nuclear reactor system for residual heat removal
110: Normal coolant circulation flow path
111: Core
112: Core inlet plenum
113: High-temperature pool
114: Intermediate heat exchanger
115: Low-temperature pool
116: Pump
120: Emergency coolant circulation flow path
121: Heat exchanger of first residual heat removal system
122: Auxiliary cooling system
130: Parallel flow path for residual heat removal
200: Nuclear reactor vessel

What is claimed is:

1. A pool-type nuclear reactor system comprising:
a normal coolant circulation flow path configured that, during normal operation, after a low-temperature coolant pumped by a pump located in a low-temperature pool flows into a core inlet plenum, the coolant is heated while passing through the core, and is accommodated into a high-temperature pool, and a high-temperature coolant located in a high-temperature pool is cooled while passing through an intermediate heat exchanger and is re-introduced into the low-temperature pool;
an emergency coolant circulation flow path configured that, in the event of a power outage accident, the high-temperature coolant located in the high-temperature pool heated by the core is cooled while passing through an auxiliary cooling system, and then is re-introduced into the core through the pump and the core inlet plenum; and
a parallel flow path for residual heat removal configured to connect the core inlet plenum and the low-temperature pool and be connected in parallel with the normal coolant circulation flow path and the emergency coolant circulation flow path.

2. The pool-type nuclear reactor system according to claim 1,
characterized in that the parallel flow path for residual heat removal has a greater flow resistance than that of the core and the pump.

3. The pool-type nuclear reactor system according to claim 2,
characterized in that, during normal operation, the coolant is branched at the core inlet plenum, and flows in parallel to the core and the parallel flow path for residual heat removal to flow into the low-temperature pool, and that, in the event of a power outage accident, the coolant is branched at the low-temperature pool, and flows in parallel to the pump and the parallel flow path for residual heat removal to flow into the core inlet plenum.

4. The pool-type nuclear reactor system according to claim 3,
characterized in that the parallel flow path for residual heat removal is configured to perform the function of a hole that charges the coolant before the nuclear reactor is operated and discharges the coolant after the nuclear reactor's lifespan is terminated.

5. The pool-type nuclear reactor system according to claim 4,
characterized in that a ratio of the area of the parallel flow path for residual heat removal to the area of the core is less than 0.85%.

6. The pool-type nuclear reactor system according to claim 5,
characterized in that the parallel flow path for residual heat removal is provided in the number of plurality.

7. The pool-type nuclear reactor system according to claim 6,
characterized in that the parallel flow path for residual heat removal is provided with a unidirectional flow restriction mechanism that blocks flow of the coolant through the parallel flow path for residual heat removal during normal operation and allows the coolant branched at the low-temperature pool to flow into the core inlet plenum through the parallel flow path for residual heat removal in the event of a power outage accident.

8. The pool-type nuclear reactor system according to claim 1,
characterized in that the auxiliary cooling system is a reactor vessel auxiliary cooling system (RVACS) that releases residual heat into the atmosphere through heat exchange with the natural circulation air on a wall surface of the reactor vessel.

9. The pool-type nuclear reactor system according to claim 1,
characterized in that the auxiliary cooling system is a direct reactor auxiliary cooling system (DRACS) that releases residual heat into the atmosphere by utilizing the number of a plurality of heat exchangers of the residual heat removal system that are sequentially connected.

10. A pool-type nuclear reactor system comprising:
a normal coolant circulation flow path configured that after a low-temperature coolant pumped by a pump located in a low-temperature pool flows into a core inlet plenum, the coolant is heated while passing through the core, and is accommodated into a high-temperature pool, and, during normal operation, a high-temperature coolant located in a high-temperature pool is cooled while passing through an intermediate heat exchanger and is re-introduced into the low-temperature pool;
an emergency coolant circulation flow path configured that, in the event of a power outage accident, after the high-temperature coolant located in the high-temperature pool heated by the core is re-introduced into the low-temperature pool, the coolant flows into the core inlet plenum through the pump and is cooled during the re-introduction process or after the re-introduction; and
a parallel flow path for residual heat removal configured to connect the core inlet plenum and the low-temperature pool so that, during normal operation, a portion of the low-temperature coolant located in the core inlet plenum flows to the low-temperature pool, and, in the event of a power outage accident, a portion of the low-temperature coolant located in the low-temperature pool flows to the core inlet plenum.

11. The pool-type nuclear reactor system according to claim 10,
characterized in that the parallel flow path for residual heat removal has a greater flow resistance than that of the core and the pump.

12. A pool-type nuclear reactor system characterized by comprising:
a core unit having a core and a core inlet plenum;
a high-temperature pool for accommodating a high-temperature coolant heated while passing through the core;
an intermediate heat exchanger for heat exchange with the high-temperature coolant of the high-temperature pool during normal operation;
an auxiliary cooling system for cooling while flowing the high-temperature coolant in the event of a power outage accident;
a low-temperature pool for accommodating a low-temperature coolant cooled by the intermediate heat exchanger or the auxiliary cooling system;
a pump that provides a driving force for flowing the low-temperature coolant located in the low-temperature pool into the core inlet plenum; and
a parallel flow path for residual heat removal that connects the core inlet plenum and the low-temperature pool and allowing the coolant to flow,
wherein the parallel flow path for residual heat removal has a preset flow resistance so that the coolant can flow from the core inlet plenum to the low-temperature pool during normal operation and flow from the low-temperature pool to the core inlet plenum in the event of a power outage accident.
